(19) United States
(12) Patent Application Publication
(10) Pub. No.: US 2018/0250883 A1
(43) Pub. Date: Sep. 6, 2018

(54) THREE-DIMENSIONAL OBJECT BUILDING METHOD AND THREE-DIMENSIONAL PRINTER

(71) Applicant: MIMAKI ENGINEERING CO., LTD., Nagano (JP)

(72) Inventors: Masaya Nagahari, Nagano (JP); Hiroyoshi Ohi, Nagano (JP); Kazuhiro Ochi, Nagano (JP)

(73) Assignee: MIMAKI ENGINEERING CO., LTD., Nagano (JP)

(21) Appl. No.: 15/908,812

(22) Filed: Mar. 1, 2018

(30) Foreign Application Priority Data
Mar. 2, 2017 (JP) 2017-039683

(51) Int. Cl. B29C 64/393; B33Y 10/00; B33Y 30/00; B33Y 50/02; B29C 64/112

(52) U.S. Cl. CPC B29C 64/393; B33Y 10/00; B29C 64/112; B33Y 50/02; B33Y 30/00

(57) ABSTRACT

A three-dimensional object building method and a three-dimensional printer capable of accurately reproducing the color of a three-dimensional object on three-dimensional data are provided. The three-dimensional object building method includes a slice information calculating process that divides three-dimensional data of a three-dimensional object into a plurality of layers to calculate cross-sectional slice information of each of the layers; a unit layer forming process that forms each layer based on the cross-sectional slice information, and repeats the unit layer forming process a plurality of times; a parameter value determining process that determines a value of a color adjustment parameter used for adjusting a color parameter for forming a color portion, according to a value of an angle of a surface of the color portion of the three-dimensional object relative to a reference plane; and a parameter reflecting process that reflects the color adjustment parameter on the cross-sectional slice information.

### CROSS REFERENCE TO RELATED APPLICATIONS

This application claims the priority benefit of Japanese Patent Application No. 2017-039683, filed on Mar. 2, 2017. The entirety of the above-mentioned patent application is hereby incorporated by reference herein and made a part of this specification.

### TECHNICAL FIELD

The present disclosure relates to a three-dimensional object building method and a three-dimensional printer.

### BACKGROUND ART

A three-dimensional object building method and a three-dimensional printer that form a three-dimensional object by depositing a building material such as ejected ink have been known. For example, a three-dimensional object building method and a three-dimensional printer disclosed in Japanese Patent Application Laid-open No. 2003-145630 described below divide three-dimensional data including an image profile representing an image of a surface overlapped with 3D model data for specifying the shape of a three-dimensional object, into a plurality of layers. The three-dimensional object building method and the three-dimensional printer create color data of the surface of the three-dimensional object for each of the layers, on the basis of cross-sectional slice information of each layer. The three-dimensional object building method and the three-dimensional printer build a three-dimensional object by sequentially building from the lower layer and depositing the layers, on the basis of the color data and the like.

Patent Literature: Japanese Patent Application Laid-open No. 2003-145630

### SUMMARY

The shape of an ink droplet 102 that is ejected from a nozzle 100 and that has landed on a horizontal landing surface 101 illustrated in FIG. 14A spreads in the horizontal direction after landing. Thus, an area (thickness) of the ink droplet 102 in the vertical direction illustrated in FIG. 14A is smaller than an area of the ink droplet 102 that has spread in the horizontal direction illustrated in FIG. 14B. In other words, as illustrated in FIG. 14B, when the landed ink droplet 102 is viewed from the above of the ejected landing surface 101, the contrast ratio of the base per unit area is increased. When the contrast ratio is increased, the color tends to become darker, and when the contrast ratio is reduced, the color tends to become lighter. In this manner, the ejected ink has large anisotropy in which the contrast ratio of the ejected ink differs greatly depending on the angle of viewing the landing surface 101 to which the ink is ejected. Consequently, in some cases, a three-dimensional object 103 built by the three-dimensional printer in Japanese Patent Application Laid-open No. 2003-145630 described above cannot form a horizontal surface 104 that is the ejected surface to be viewed from the above in the same color with a side surface 105 that is the ejected surface to be viewed from the side, even if the horizontal surface 104 illustrated in FIG. 14C and the side surface 105 (vertical surface) illustrated in FIG. 14D have the same color on three-dimensional data. In this manner, some of the three-dimensional objects 103 built by the three-dimensional printer in Japanese Patent Application Laid-open No. 2003-145630 described above have been prevented from accurately reproducing the color on the three-dimensional data. Moreover, in the three-dimensional object 103 built by the three-dimensional printer disclosed in Japanese Patent Application Laid-open No. 2003-145630 described above, the surface state of the landed ink sometimes differ, depending on the viewing direction. In FIG. 14C and FIG. 14D, a clear portion formed of transparent ink is indicated in white and a portion formed of the colored ink droplet 102 is indicated by oblique parallel lines.

The present disclosure has been made in view of the above, and the present disclosure provides a three-dimensional object building method and a three-dimensional printer capable of accurately reproducing the color and the surface state of a three-dimensional object on three-dimensional data.

In view of above description, a three-dimensional object building method according to the present disclosure is provided and includes a slice information calculating process that divides a three-dimensional data of a three-dimensional object at least a part of which includes a colored layer into a plurality of layers, to calculate a cross-sectional slice information of each of the layers; a unit layer forming process that forms each of the layers based on the cross-sectional slice information, wherein the three-dimensional object building method builds the three-dimensional object by using a three-dimensional printer, and by repeating the unit layer forming process a plurality of times to deposit the layers; a parameter value determining process that determines a value of a color adjustment parameter used for adjusting a color parameter for forming the colored layer and/or a value of a surface state adjustment parameter used for adjusting a surface state of the colored layer, according to a value corresponding to an angle of a surface of the colored layer of the three-dimensional object relative to a horizontal reference plane; and a parameter reflecting process that reflects the value of the color adjustment parameter and/or the value of the surface state adjustment parameter used for adjusting the surface state of the colored layer determined in the parameter value determining process on at least one of the three-dimensional data and the cross-sectional slice information.

With this disclosure, for example, it is possible to suitably adjust the color parameter depending on the angle of the surface of the colored layer with which the color becomes lighter when the colored layer is in a more horizontal state, the color becomes darker when the colored layer is in a more vertical state, and the like. This is because the value of the color adjustment parameter and/or the value of the surface state adjustment parameter are adjusted according to the value corresponding to the angle of the surface of the colored layer relative to the reference plane. Consequently, it is possible to accurately reproduce the color and/or the surface state of the three-dimensional object on the three-dimensional data.

Moreover, in the three-dimensional object building method described above, the color adjustment parameter is a value for adjusting at least one of an ejection amount of an ink that forms the colored layer, an ink density, a thickness of the colored layer, and a shade of the colored layer.

With this disclosure, it is possible to suitably adjust the color parameter depending on the angle of the colored layer, and adjust the color parameter so as the color viewed at different viewing angles is uniform even if the thickness of the colored layer is constant. This is because the color adjustment parameter is a value for adjusting at least one of the ejection amount of ink that forms the colored layer, the ink density, the thickness of the colored layer, and the shade of the colored layer. Consequently, it is possible to lighten the color, particularly when the user wishes to lighten the color but the thickness of the colored layer cannot be reduced, and to accurately reproduce the color of a three-dimensional object on the three-dimensional data.

Moreover, in the three-dimensional object building method described above, the surface state adjustment parameter is a value for adjusting the thickness of each layer in the unit layer forming process.

With this disclosure, it is possible to adjust the surface state because the surface state adjustment parameter is a value for adjusting the thickness of each layer in the unit layer forming process.

Moreover, the three-dimensional object building method includes an angle calculating process for calculating a value corresponding to the angle, by using a positional information on the surface of the three-dimensional object included in the three-dimensional data.

With this disclosure, it is possible to accurately determine the value of the color adjustment parameter, because the value corresponding to the angle of the surface of the colored layer is calculated on the basis of the positional information on the surface of the three-dimensional object.

In the three-dimensional object building method described above, the surface of the three-dimensional object is divided into a plurality of unit cells that are polygonal planes in the three-dimensional data, and an angle between the normal vector of each of the unit cells and the horizontal reference plane is calculated as a value of the angle in the angle calculating process.

With this disclosure, it is possible to calculate the angle of the surface of the colored layer in a precise manner, form each position on the surface of a three-dimensional object in a suitable color, and obtain a high-quality image. This is because the angle between the normal vector of the unit cell and the reference plane is a value corresponding to the angle of the surface of the colored layer relative to the reference plane.

Moreover, in the three-dimensional object building method described above, the adjacent unit cells form a color unit in the three-dimensional data; and the average angle of angles between each of the normal vectors of the unit cells that form the color unit and the horizontal reference plane is calculated, and the value of the color adjustment parameter is determined on the basis of the average angle for each color unit in the parameter value determining process.

With this disclosure, it is possible to reduce the time required for calculating the value of the color adjustment parameter, because the color adjustment parameter is calculated on the basis of the average angle of the unit cells of the color unit.

Moreover, in the three-dimensional object building method, fluctuations of an angle of each of the normal vectors of the unit cells that form the color unit are a predetermined value or less.

With this disclosure, it is possible to keep the surface of the unit cells that form the color unit in substantially parallel, because the fluctuations of each of the normal vectors of the unit cells that form the color unit are a predetermined value or less. Consequently, it is possible to obtain a high-quality image, even if the time required for calculating the color adjustment parameter is reduced.

In the three-dimensional object building method described above, the value of the color adjustment parameter determined in the parameter value determining process is reflected on the three-dimensional data in the parameter reflecting process, and the three-dimensional data reflected with the color adjustment parameter is divided into a plurality of layers to calculate the cross-sectional slice information of each of the layers in the slice information calculating process.

With this disclosure, it is possible to accurately reproduce the color of a three-dimensional object on the three-dimensional data, because the cross-sectional slice information is calculated after the color adjustment parameter is reflected on the three-dimensional data.

A three-dimensional printer according to the present disclosure is a three-dimensional printer that builds a three-dimensional object based on a three-dimensional data of the three-dimensional object at least a part of which includes a colored layer, the three-dimensional printer includes an ejection unit that ejects an ink for building the three-dimensional object on a landing surface; a relative moving unit that relatively moves the ejection unit and the landing surface; and a control device that controls the ejection unit and the relative moving unit, wherein the control device builds the three-dimensional object by performing a slice information calculating process that divides the three-dimensional data into a plurality of layers to calculate a cross-sectional slice information of each of the layers, and a unit layer forming process that forms each of the layers based on the cross-sectional slice information, and by repeating the unit layer forming process a plurality of times to deposit the layers; and the control device performs a parameter value determining process that determines a value of a color adjustment parameter used for adjusting a color parameter for forming a colored layer, according to a value of an angle of a surface of the colored layer of the three-dimensional object relative to a horizontal reference plane, and a parameter reflecting process that reflects the color adjustment parameter determined in the parameter value determining process on at least one of the three-dimensional data and the cross-sectional slice information.

With this disclosure, for example, it is possible to suitably adjust the color parameter depending on the angle of the surface of the colored layer with which the color becomes darker when the colored layer is in a more horizontal state, the color becomes lighter when the colored layer is in a more vertical state, and the like. This is because the color parameter is adjusted by the color adjustment parameter according to the value corresponding to the angle of the surface of the colored layer relative to the reference plane. Consequently, it is possible to accurately reproduce the color of a three-dimensional object on the three-dimensional data.

The three-dimensional object building method and the three-dimensional printer according to the present disclosure are capable of advantageously and accurately reproducing the color of a three-dimensional object on three-dimensional data.

### BRIEF DESCRIPTION OF THE DRAWINGS

FIG. 1 is a schematic configuration diagram illustrating a schematic configuration of an inkjet printer according to an embodiment.

FIG. 2 is a flowchart of a three-dimensional object building method according to the embodiment.

FIG. 3 is a perspective view illustrating an example of a three-dimensional object to be built by the inkjet printer illustrated in FIG. 1.

FIG. 4 is a sectional view cut along a line IV-IV in FIG. 3.

FIG. 5 is a diagram illustrating 3D model data in three-dimensional data of the three-dimensional object illustrated in FIG. 3.

FIG. 6 is an enlarged view of an essential part of the 3D model data illustrated in FIG. 5.

FIG. 7 is a diagram for explaining a color adjustment parameter of an image profile in the three-dimensional object building method according to the embodiment.

FIG. 8 is a diagram for explaining a color adjustment parameter of an image profile in a three-dimensional object building method according to a first modification of the embodiment.

FIG. 9 is a flowchart illustrating a parameter value determining process in a three-dimensional object building method according to a second modification of the embodiment.

FIG. 10 is a flowchart of a three-dimensional object building method according to a third modification of the embodiment.

FIG. 11 is a diagram for explaining a color adjustment parameter of an image profile in the three-dimensional object building method according to the third modification of the embodiment.

FIG. 12 is a flowchart of a three-dimensional object building method according to a fourth modification of the embodiment.

FIG. 13 is a diagram illustrating a modification of three-dimensional data of a three-dimensional object.

FIG. 14A to FIG. 14D are schematic diagrams for explaining a conventional building method using an inkjet printer, FIG. 14A is a state when an ink droplet that is ejected from a nozzle and that has landed on a landing surface is viewed from the side of the landing surface, FIG. 14B is a state when the ink droplet that is ejected from the nozzle and that has landed on the landing surface is viewed from the above, FIG. 14C is a schematic diagram for explaining a contrast ratio when a three-dimensional object is built by the conventional building method and is viewed from the above of the base, and FIG. 14D is a schematic diagram for explaining a contrast ratio when the three-dimensional object is built by the conventional building method and is viewed from the side of the base.

### DESCRIPTION OF EMBODIMENTS

Hereinafter, an embodiment of a three-dimensional object building method and a three-dimensional printer according to the present disclosure will be described in detail with reference to the accompanying drawings. It is to be noted that this disclosure is not to be limited by the embodiment. Components in the following embodiment include components that can be easily replaced by those skilled in the art, or components substantially the same.

### EMBODIMENTS

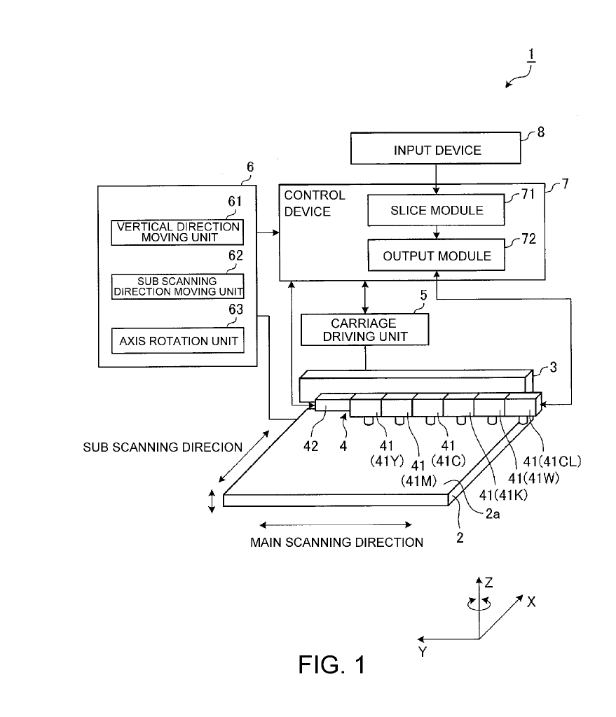

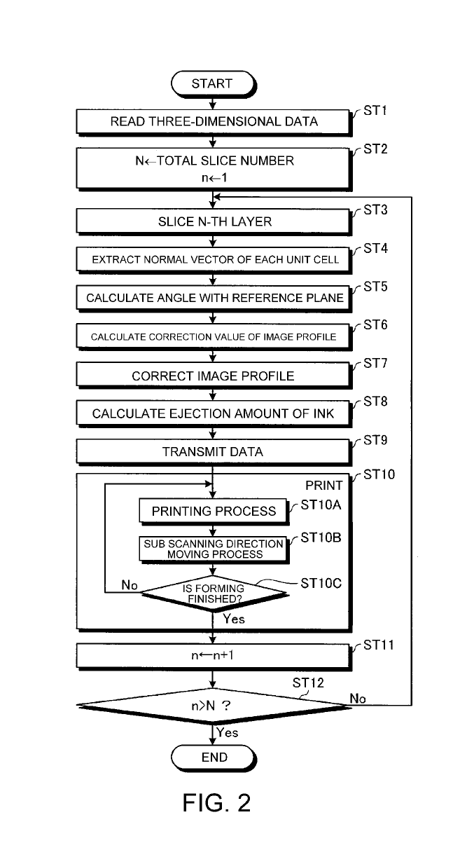

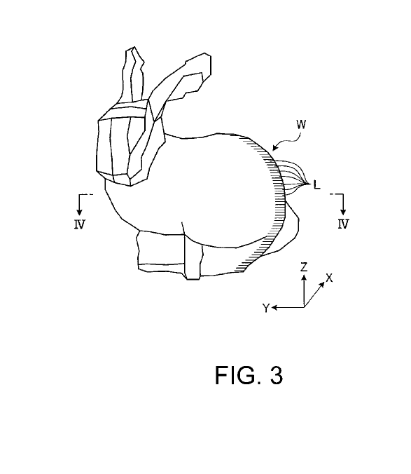

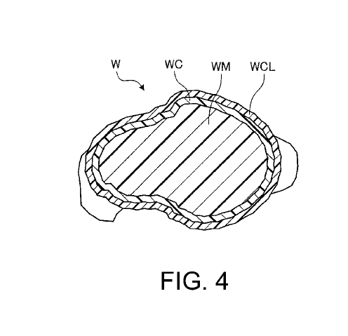

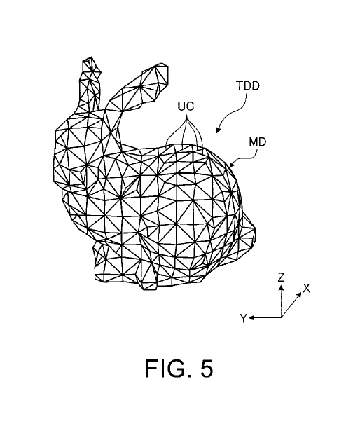

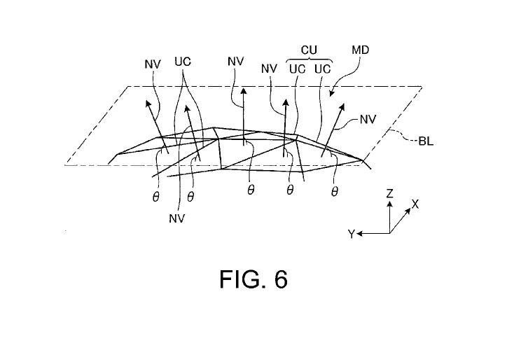

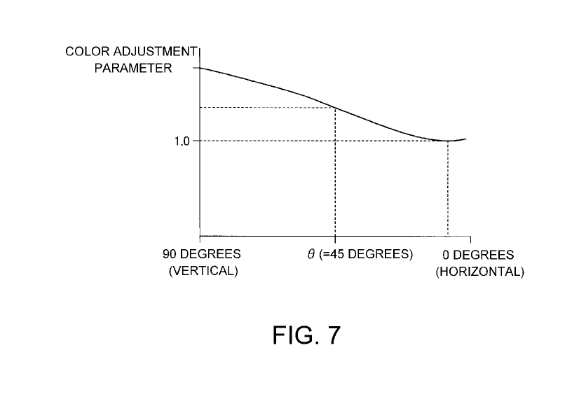

FIG. 1 is a schematic configuration diagram illustrating a schematic configuration of an inkjet printer according to an embodiment. FIG. 2 is an example of a flowchart of a three-dimensional object building method according to the embodiment. FIG. 3 is a perspective view illustrating an example of a three-dimensional object to be built by the inkjet printer illustrated in FIG. 1. FIG. 4 is a sectional view cut along a line IV-IV in FIG. 3. FIG. 5 is a diagram illustrating 3D model data in three-dimensional data of the three-dimensional object illustrated in FIG. 3. FIG. 6 is an enlarged view of an essential part of the 3D model data illustrated in FIG. 5. FIG. 7 is a diagram for explaining a color adjustment parameter of an image profile in the three-dimensional object building method according to the embodiment.

An inkjet printer 1 serving as a three-dimensional printer according to the embodiment illustrated in FIG. 1 is a three-dimensional object building device that manufactures a three-dimensional object W (an example is illustrated in FIG. 3) that is a three-dimensional object, by using what is called an inkjet method. Typically, the inkjet printer 1 builds the three-dimensional object W matching with three-dimensional data TDD (a part is illustrated in FIG. 5) representing the shape and the surface image of the three-dimensional object W, by dividing the three-dimensional object W into a plurality of layers L (illustrated in FIG. 3) in the vertical direction on the basis of the three-dimensional data TDD, and by sequentially depositing a building material (cured ink) from the lower layer L on the basis of 3D model data MD representing the shape of the three-dimensional object W of each of the layers L and an image profile representing the surface image.

As illustrated in FIG. 4, the three-dimensional object W includes a model portion WM that is built with white (W) ink; a color portion WC (corresponds to colored layer) that is formed on the surface of the model portion WM and that is formed of yellow (Y) ink, magenta ink (M), cyan (C) ink, and black (K) ink; and a clear portion WCL that covers the color portion WC and that is formed of transparent ink. Thus, at least a part of the surface of the three-dimensional object W includes the color portion WC, because the clear portion WCL is transparent and the color portion WC can be viewed through the clear portion WCL. An example of the three-dimensional object W illustrated in FIG. 3 is formed in a seated rabbit shape. However, in the present disclosure, the shape of the three-dimensional object W is not limited thereto.

As illustrated in FIG. 1, the inkjet printer 1 includes a placing table 2 the top surface of which is a working surface 2a (corresponds to a landing surface), a Y bar 3 provided in a main scanning direction, a carriage 4, a carriage driving unit 5 (corresponding to a relative moving unit), a placing table driving unit 6 (corresponds to a relative moving unit), a control device 7, and an input device 8.

The working surface 2a of the placing table 2 is a plane formed flat in the horizontal direction (direction parallel to the X-axis and the Y-axis illustrated in FIG. 1) and on which ink serving as a building material is sequentially deposited from the lower layer L. For example, the placing table 2 is formed in a substantially rectangular shape. However, it is not limited thereto.

The Y bar 3 is provided on the upper side of the placing table 2 in the vertical direction at a predetermined interval. The Y bar 3 is linearly provided along the main scanning direction that is parallel to the horizontal direction (Y-axis). The Y bar 3 guides the reciprocating movement of the carriage 4 along the main scanning direction.

The carriage 4 is held by the Y bar 3 and is capable of reciprocally moving in the main scanning direction along the Y bar 3. The movement of the carriage 4 is controlled in the main scanning direction. A plurality of ejection units 41 and an ultraviolet ray irradiator 42 (corresponds to an external stimulus applying unit) are provided on the carriage 4, on a surface facing the placing table 2 relative to the vertical direction, via a holder or the like, which is not illustrated.

Each of the ejection units 41 ejects ink serving as a building material for building the three-dimensional object W, on the working surface 2a. The ejection unit 41 of the embodiment is at least capable of ejecting ink on the working surface 2a and relatively moving with the working surface 2a by the carriage driving unit 5. Ink that changes the degree of cure upon exposure may be used as the ink.

The ejection unit 41 is capable of reciprocally moving in the main scanning direction with the movement of the carriage 4 in the main scanning direction. The ejection unit 41 is connected to an ink tank via various ink channels, a regulator, a pump, and the like. The ejection unit 41 is provided according to the number of ink tanks, in other words, according to the number of ink colors that can be printed at the same time and the like. The present embodiment includes an ejection unit 41Y that ejects yellow (Y) ink, an ejection unit 41M that ejects magenta (M) ink, an ejection unit 41C that ejects cyan (C) ink, an ejection unit 41K that ejects black (K) ink, an ejection unit 41W that ejects white (W) ink, and an ejection unit 41CL that ejects clear (CL) ink.

The ejection units 41Y, 41M, 41C, 41K, 41W, and 41CL are each an inkjet ejection unit capable of ejecting ink inside the ink tank toward the working surface 2a by the inkjet method. For example, the ink that changes the degree of cure upon exposure may be ultraviolet (UV) curable ink that is cured by being irradiated with ultraviolet rays. For example, the ink is preferably highly water soluble, highly alcohol soluble, or heat-soluble after curing. The ejection units 41Y, 41M, 41C, 41K, 41W, and 41CL are each electrically connected to the control device 7, and the control device 7 controls the drive of the ejection units 41Y, 41M, 41C, 41K, 41W, and 41CL. The ejection units 41Y, 41M, 41C, 41K, 41W, and 41CL are disposed in the Y-axis direction. In this manner, by providing the ejection units 41Y, 41M, 41C, 41K, 41W, and 41CL, the inkjet printer 1 can at least eject three primary colors. Moreover, the contrast ratio of the ink that is ejected from the ejection units 41Y, 41M, 41C, and 41K and that forms the color portion WC is increased, when the ink that has landed on the landing surface is viewed from the above of the landing surface, because the ink widely covers the base. The contrast ratio of the ink is reduced, when the ink that has landed on the landing surface is viewed from the side of the landing surface, because the ink does not widely cover the base.

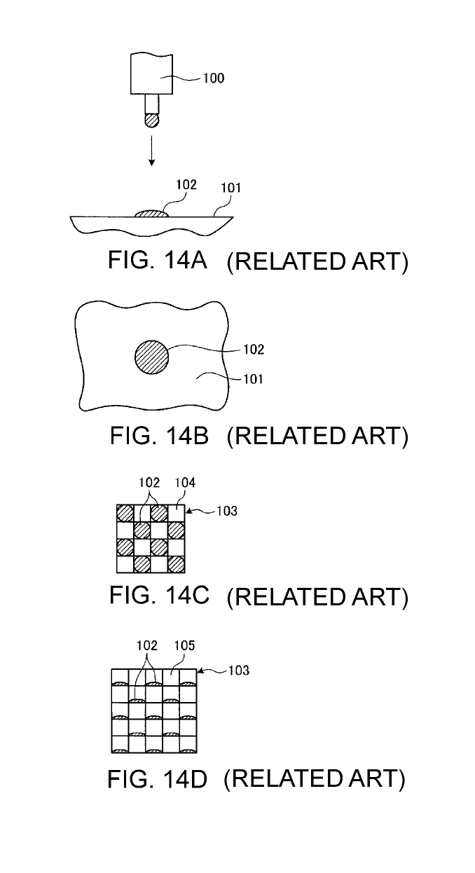

The contrast ratio described above will now be explained with reference to FIG. 14A to FIG. 14D. FIG. 14A to FIG. 14D are schematic diagrams for explaining a conventional building method using an inkjet printer. FIG. 14A is a state when an ink droplet that is ejected from a nozzle and that has landed on a landing surface is viewed from the side of the landing surface. FIG. 14B is a state when the ink droplet that is ejected from the nozzle and that has landed on the landing surface is viewed from the above. FIG. 14C is a schematic diagram for explaining a contrast ratio when a three-dimensional object that is built by the conventional building method is viewed from the above of the base. FIG. 14D is a schematic diagram for explaining a contrast ratio when a three-dimensional object that is built by the conventional building method is viewed from the side of the base. As described in above discussion and as illustrated in FIG. 14A and FIG. 14B, when general ink is landed on the landing surface 101, the ink droplet 102 spreads in the horizontal direction by gravity and surface tension, but the ink droplet 102 does not spread (project) in the vertical direction as much as the horizontal direction. When such ink droplets 102 are deposited to build the three-dimensional object 103, as illustrated in FIG. 14C and FIG. 14D, the contrast ratio of the base differs greatly between when the three-dimensional object 103 is viewed from the deposition direction (FIG. 14C), and when the three-dimensional object 103 is viewed from a direction intersecting with the deposition direction, in other words, when the side surface of the three-dimensional object is viewed (FIG. 14D). The difference in the contrast ratio such as the above affects the color density of the three-dimensional object 103. Thus, the density differs depending on the viewing angle of the three-dimensional object 103.

The ultraviolet ray irradiator 42 applies external stimulus to the ink ejected on the working surface 2a. The ultraviolet ray irradiator 42 can expose the ink supplied to the working surface 2a. For example, the ultraviolet ray irradiator 42 includes a light-emitting diode (LED) module capable of emitting ultraviolet rays. The ultraviolet ray irradiator 42 is provided on the carriage 4, and is capable of reciprocally moving in the main scanning direction with the movement of the carriage 4 in the main scanning direction. The ultraviolet ray irradiator 42 is electrically connected to the control device 7, and the control device 7 controls the drive of the ultraviolet ray irradiator 42.

The carriage driving unit 5 is a driving device for relatively and reciprocally moving the carriage 4, in other words, the ejection units 41Y, 41M, 41C, 41K, 41W, and 41CL, and the ultraviolet ray irradiator 42 in the main scanning direction relative to the Y bar 3. For example, the carriage driving unit 5 includes a transfer mechanism such as a conveying belt connected to the carriage 4, and a driving source such as an electric motor for driving the conveying belt. The carriage driving unit 5 reciprocally moves the carriage 4 in the main scanning direction, by converting electric power generated by the driving source to electric power used for moving the carriage 4 in the main scanning direction via the transfer mechanism. The carriage driving unit 5 is electrically connected to the control device 7, and the control device 7 controls the drive of the carriage driving unit 5.

The carriage driving unit 5 and the placing table driving unit 6 relatively move the ejection units 41Y, 41M, 41C, 41K, 41W, and 41CL, and the working surface 2a. As illustrated in FIG. 1, the placing table driving unit 6 includes a vertical direction moving unit 61, a sub scanning direction moving unit 62, and an axis rotation unit 63. The vertical direction moving unit 61 relatively moves the working surface 2a formed on the placing table 2 in the vertical direction relative to the ejection units 41Y, 41M, 41C, 41K, 41W, and 41CL, and the ultraviolet ray irradiator 42, by moving the placing table 2 in the vertical direction parallel to the Z-axis. Consequently, the placing table driving unit 6 can make the working surface 2a approach and separate to and from the ejection units 41Y, 41M, 41C, 41K, 41W, and 41CL, and the ultraviolet ray irradiator 42 in the vertical direction. In other words, the placing table driving unit 6 is capable of relatively moving the working surface 2a in the vertical direction relative to the ejection units 41Y, 41M, 41C, 41K, 41W, and 41CL, and the ultraviolet ray irradiator 42.

The sub scanning direction moving unit 62 relatively and reciprocally moves the working surface 2a formed on the placing table 2 in the sub scanning direction relative to the ejection units 41Y, 41M, 41C, 41K, 41W, and 41CL, and the ultraviolet ray irradiator 42, by moving the placing table 2 in the sub scanning direction that is parallel to the X-axis being perpendicular to the main scanning direction. Consequently, the placing table driving unit 6 can reciprocally move the working surface 2a in the sub scanning direction relative to the ejection units 41Y, 41M, 41C, 41K, 41W, and 41CL, and the ultraviolet ray irradiator 42. In other words, the sub scanning direction moving unit 62 is capable of relatively and reciprocally moving the ejection units 41Y, 41M, 41C, 41K, 41W, and 41CL, the ultraviolet ray irradiator 42, and the working surface 2a in the sub scanning direction. In the embodiment, the sub scanning direction moving unit 62 moves the placing table 2 in the sub scanning direction. However, the present disclosure is not limited thereto, and the sub scanning direction moving unit 62 may also move the ejection units 41Y, 41M, 41C, 41K, 41W, and 41CL, and the ultraviolet ray irradiator 42 in the sub scanning direction with the Y bar 3.

The axis rotation unit 63 relatively rotates the working surface 2a formed on the placing table 2 around the axis (Z-axis) parallel to the vertical direction, relative to the ejection units 41Y, 41M, 41C, 41K, 41W, and 41CL, and the ultraviolet ray irradiator 42, by rotating the placing table 2 around the axis. Consequently, the placing table driving unit 6 is capable of rotating the working surface 2a around the axis, relative to the ejection units 41Y, 41M, 41C, 41K, 41W, and 41CL, and the ultraviolet ray irradiator 42. In other words, the axis rotation unit 63 is capable of rotating the ejection units 41Y, 41M, 41C, 41K, 41W, and 41CL, the ultraviolet ray irradiator 42, and the working surface 2a around the axis parallel to the vertical direction.

The control device 7 controls the units of the inkjet printer 1 including the ejection units 41Y, 41M, 41C, 41K, 41W, and 41CL, the ultraviolet ray irradiator 42, the carriage driving unit 5, and the placing table driving unit 6. The control device 7 includes hardware such as an arithmetic unit and a memory, and computer programs for implementing certain functions of the hardware. The control device 7 controls the ejection units 41Y, 41M, 41C, 41K, 41W, and 41CL, and controls the ejection amount, the ejection timing, the ejection period, and the like of the ink of each of the ejection units 41Y, 41M, 41C, 41K, 41W, and 41CL. The control device 7 controls the ultraviolet ray irradiator 42, and controls the intensity of ultraviolet rays to be emitted, the exposure timing, the exposure period, and the like. The control device 7 controls the carriage driving unit 5, and controls the relative movement of the carriage 4 in the main scanning direction. The control device 7 controls the placing table driving unit 6, and controls the relative movement of the placing table 2 in the vertical direction and in the sub scanning direction, and the relative movement of the placing table 2 around the axis. The control device 7 includes a slice module 71 that divides the three-dimensional data TDD input from the input device 8 to the layers L to calculate cross-sectional slice information of each of the layers L. The control device 7 also includes an output module 72 that analyzes the cross-sectional slice information and the like.

The input device 8 is connected to the control device 7, and enters the three-dimensional data TDD representing the shape and the surface image of the three-dimensional object W. For example, the input device 8 includes a personal computer (PC) that is wired or wirelessly connected to the control device 7, and various terminals.

Next, an example of a three-dimensional object building method that is to be carried out by the inkjet printer 1 described above will be explained with reference to the flowchart in FIG. 2. The three-dimensional object building method illustrated in FIG. 2 is carried out by the control device 7 in the inkjet printer 1. An explanation of FIG. 2 will be given with reference to FIG. 5 to FIG. 7 as appropriate.

The three-dimensional object building method of the embodiment is a method for manufacturing the three-dimensional object W, and is performed when the control device 7 of the inkjet printer 1 controls the drive of the units in the inkjet printer 1. The three-dimensional object building method includes a slice information calculating process (step ST3) that divides the three-dimensional data TDD of the three-dimensional object W into the layers L to calculate cross-sectional slice information of each of the layers L; and a unit layer forming process (step ST10) that forms each of the layers L on the basis of the cross-sectional slice information. The three-dimensional object building method is a method for building the three-dimensional object W by using the inkjet printer 1, by repeating the unit layer forming processes (step ST10) a plurality of times to deposit the layers L. Moreover, the three-dimensional object building method of the embodiment builds the three-dimensional object W so as the color of the color portion WC becomes lighter as the surface of the three-dimensional object W approaches the horizontal state, and the color of the color portion WC becomes darker as the surface of the three-dimensional object W approaches the vertical state.

In the three-dimensional object building method, the three-dimensional data TDD (illustrated in FIG. 5) of the three-dimensional object W is first read from the input device 8 to the control device 7 (step ST1). In the embodiment, the three-dimensional data TDD includes the 3D model data MD and the image profile. The 3D model data MD is data for specifying the shape of the three-dimensional object W. As illustrated in FIG. 5, the surface of the three-dimensional object W is divided into a plurality of unit cells UC that are triangular (polygonal) planes. The 3D model data MD includes data representing coordinates of the vertex of each of the unit cells UC on the X-axis, the Y-axis, and the Z-axis; a normal vector NV (illustrated in FIG. 6) of each of the unit cells UC; and texture data representing an RGB image of the surface of the 3D model data MD. In the 3D model data MD in the three-dimensional data TDD, a color unit CU is formed of a plurality of adjacent unit cells UC.

The image profile is data for building the surface image of the three-dimensional object W, and the density of each color (corresponds to a color parameter) of yellow (Y), magenta (M), cyan (C), and black (K) of each of the unit cells UC of the 3D model data MD is indicated by a plurality of gradation levels such as 256 levels and 65536 levels, for example.

Next, after the three-dimensional data TDD is read by the control device 7 (step ST1), the slice module 71 calculates the numbers N of the layers L that divide the three-dimensional data TDD of the three-dimensional object W in the Z-axis direction, on the basis of the 3D model data MD in the three-dimensional data TDD and the size of the ink droplet ejected from the ejection units 41Y, 41M, 41C, 41K 41W, and 41CL (step ST2). Specifically, the control device 7 calculates the height of the three-dimensional object W in the Z-axis direction on the basis of the 3D model data MD, and calculates the numbers N of the layers L by dividing the calculated height by the height corresponding to the size of the ink droplet. Moreover, at step ST2, the control device 7 acquires n=1.

Next, the slice module 71 of the control device 7 performs the slice information calculating process (step ST3) by dividing the three-dimensional data TDD into the layers L to calculate cross-sectional slice information of each of the divided layers L (in the first round of a loop from step ST3 to step ST12, the lowest layer L).

The slice module 71 of the control device 7 divides the three-dimensional data TDD into the layers L in the slice information calculating process (step ST3), and calculates the cross-sectional slice information of the height corresponding to the size of the ink droplet ejected by the inkjet printer 1 in the slice information calculating process (step ST3). In the first round of the loop from step ST3 to step ST12, the slice module 71 calculates the cross-sectional slice information of the lowest layer L. The cross-sectional slice information includes three-dimensional coordinate data representing the coordinates on the X-axis, the Y-axis, and the Z-axis of each of the unit cells UC of each of the layers L, the normal vector NV of each of the unit cells UC, texture data of each of the unit cells UC, and the image profile of each of the unit cells UC.

Next, the slice module 71 of the control device 7 extracts the normal vector NV of each of the unit cells UC in the cross-sectional slice information (step ST4). Next, the slice module 71 of the control device 7 performs an angle calculating process (step ST5) that calculates angle θ between each normal vector NV and a reference plane BL (illustrated in FIG. 6) that is parallel to the X-axis and Y-axis, in other words, horizontal to the X-axis and Y-axis. The angle θ is a value corresponding to the angle of the surface of the color portion WC of the three-dimensional object W relative to the reference plane BL. Moreover, in the angle calculating process (step ST5), the control device 7 may also calculate the angle of the surface of the color portion WC of the three-dimensional object W relative to the reference plane BL, by using the positional information (coordinates on the X-axis, the Y-axis, and the Z-axis) of the vertex of each of the unit cells UC of the 3D model data MD in the three-dimensional data TDD. The positional information on the vertex of each of the unit cells UC corresponds to the positional information on the surface of the three-dimensional object W included in the three-dimensional data TDD. In this manner, in the present disclosure, for example, a value corresponding to the angle of the surface of the color portion WC of the three-dimensional object W relative to the reference plane BL is the angle θ and the like.

Next, the output module 72 of the control device 7 performs a parameter value determining process (step ST6) that determines the value of a color adjustment parameter used for adjusting the color parameter of the image profile for forming the color portion WC, according to the value corresponding to the angle of the surface of the color portion WC of the three-dimensional object W relative to the reference plane BL. Specifically, as illustrated in FIG. 7, the output module 72 of the control device 7 determines the value of the color adjustment parameter of each of the unit cells UC, on the basis of a relation between the angle θ and the color adjustment parameter. The horizontal axis in FIG. 7 represents the angle θ, and the vertical axis represents the value of the color adjustment parameter that is to be multiplied by the density of each color of yellow (Y), magenta (M), cyan (C), and black (K) of the image profile. In FIG. 7, when the angle θ is 0 degrees, the value of the color adjustment parameter is 1.0. When the angle θ is greater than 0 degrees, in other words, when the surface of the color portion WC is inclined from the horizontal state, the value of the color adjustment parameter exceeds 1.0. When the angle θ exceeds 45 degrees, in other words, when the surface of the color portion WC approaches the vertical state, the value of the color adjustment parameter is increased furthermore (for example, exceeds 2.0).

In the parameter value determining process (step ST6), the output module 72 of the control device 7 may determine the value of a surface state adjustment parameter according to the value corresponding to the angle of the surface of the color portion WC of the three-dimensional object W relative to the reference plane BL, instead of determining the value of the color adjustment parameter. The surface state adjustment parameter is a parameter representing the flatness of the surface (surface roughness) of the color portion WC. Specifically, similar to determining the value of the color adjustment parameter, the output module 72 of the control device 7 determines the value of the surface state adjustment parameter of each of the unit cells UC, on the basis of a relation between the angle θ and the surface state adjustment parameter. In some cases, the control device 7 may determine the value of the color adjustment parameter and the value of the surface state adjustment parameter, in the parameter value determining process (step ST6).

The relation between the angle θ and the surface state adjustment parameter depends on the material and the building method. However, for example, when a support body is formed along the contour of the three-dimensional object W, the surface roughness is reduced when the angle θ is 0 degrees, and the surface roughness is increased when the angle θ is greater than 0 degrees, in other words, when the surface of the color portion WC is inclined from the horizontal state. The surface roughness is further increased when the angle θ exceeds 45 degrees, in other words, when the surface of the color portion WC approaches the vertical state. In such a case, the surface roughness may be reduced by setting the surface state adjustment parameter when the angle θ is 0 degrees as the reference value (1.0), and by increasing the surface state adjustment parameter to more than the reference value (1.0) with an increase in the angle θ greater than 0 degrees.

Next, the output module 72 of the control device 7 performs a parameter reflecting process (step ST7) that reflects, on the cross-sectional slice information, the value of the color adjustment parameter and/or the value of the surface state adjustment parameter determined in the parameter value determining process (step ST6). Specifically, in the parameter value determining process (step ST6), the output module 72 of the control device 7 multiplies the value of the color adjustment parameter calculated for each of the unit cells UC by the density of each color of the image profile, ink density, thickness and shade (saturation, brightness, contrast, and the like) of the color portion WC that is a colored layer. In other words, in the embodiment, the value of the color adjustment parameter is a value for adjusting the ejection amount of each kind of ink that forms the color portion WC. The ejection amount of ink represents the number of ink droplets or the size of the ink droplet (ejection amount of one droplet) ejected by the ejection units 41Y, 41M, 41C, and 41K per unit area of the color portion WC.

The output module 72 of the control device 7 then generates the ejection amount and the ejection pattern of each of the ejection units 41Y, 41M, 41C, 41K, 41W, and 41CL for each of the layers L of the three-dimensional object W, on the basis of the corrected image profile, the cross-sectional slice information, and the like. The output module 72 of the control device 7 also generates an ejection control amount capable of implementing the generated ejection pattern, a curing control amount, a control amount of the carriage driving unit 5 and the placing table driving unit 6, and the like (step ST8).

Next, the output module 72 of the control device 7 transmits the ejection amount of each of the ejection units 41Y, 41M, 41C, 41K, 41W, and 41CL, the ejection control amount capable of implementing the ejection pattern, the curing control amount, the control amount of the carriage driving unit 5 and the placing table driving unit 6, and the like, to the carriage driving unit 5, the placing table driving unit 6, the ejection units 41Y, 41M, 41C, 41K, 41W, and 41CL, and the ultraviolet ray irradiator 42 (step ST9).

Next, the control device 7 performs the unit layer forming process (step ST10) that causes the inkjet printer 1 to form each layer L on the basis of the cross-sectional slice information. In the unit layer forming process (step ST10), the control device 7 shapes each layer L by relatively moving the ejection units 41Y, 41M, 41C, 41K, 41W, and 41CL, and the ultraviolet ray irradiator 42 in the main scanning direction as the generated ejection pattern; causing the ejection units 41Y, 41M, 41C, 41K, 41W, and 41CL to eject ink onto the working surface 2a and causing the ultraviolet ray irradiator 42 to expose the ejected ink, while relatively rotating the placing table 2 around the axis in the sub scanning direction.

Specifically, the unit layer forming process includes a printing process (step ST10A) and a sub scanning direction moving process (step ST10B). In the printing process (step ST10A), the control device 7 controls the carriage driving unit 5, the vertical direction moving unit 61, and the axis rotation unit 63, and places the carriage 4 at a suitable position relative to the working surface 2a. While causing the carriage driving unit 5 to move the ejection units 41Y, 41M, 41C, 41K, 41W, and 41CL, and the ultraviolet ray irradiator 42 in the main scanning direction, the control device 7 causes the ejection units 41Y, 41M, 41C, 41K, 41W, and 41CL to eject ink at a suitable timing for forming the layers L generated in the ejection pattern generating process, and causes the ultraviolet ray irradiator 42 to emit ultraviolet rays. The ejected ink lands on the working surface 2a or the layer L that has been built (corresponds to the landing surface) to be cured. The control device 7 forms one row of the layer L in the main scanning direction, by causing the carriage 4 to move in the main scanning direction once or more, causing the ejection units 41Y, 41M, 41C, 41K, 41W, and 41CL to eject ink, and exposing and curing the ejected ink.

In the sub scanning direction moving process (step ST10B), the control device 7 relatively moves the ejection units 41Y, 41M, 41C, 41K, 41W, and 41CL, the ultraviolet ray irradiator 42, and the working surface 2a in the sub scanning direction, by controlling the sub scanning direction moving unit 62 and moving the placing table 2 in the sub scanning direction as much as one row. The control device 7 then determines whether forming of each layer L is finished (step ST10C). When it is determined that forming of each layer L is not finished (No at step ST10C), the control device 7 forms a plurality of rows by alternatively performing the printing process (step ST10A) and the sub scanning direction moving process (step ST10B). When it is determined that forming of each layer L is finished (Yes at step ST10C), the control device 7 finishes building all of the layers L.

Next, the control device 7 acquires n=n+1 (step ST11), and determines whether n has exceeded N (step ST12). When it is determined that n has not exceeded N (No at step ST12), the control device 7 returns to the slice information calculating process (step ST3). After calculating the next cross-sectional slice information, the control 7 controls the vertical direction moving unit 61 and sets the position of the working surface 2a in the vertical direction at a position suitable for building the next layer L, by lowering the working surface 2a as much as one layer L. The control device 7 then builds the layers L by repeating the processes from the slice information calculating process (step ST3) to the unit layer forming process (step ST10) a plurality of times.

By repeating the processes described above, in other words, by repeating the unit layer forming process (step ST10) for each layer L, the control device 7 sequentially builds the three-dimensional object W from the lower layer L. When it is determined that n has exceeded N (Yes at step ST12), the control device 7 finishes building the three-dimensional object W, and finishes the three-dimensional object building method of the embodiment by removing the three-dimensional object W from the working surface 2a and the like. The finished three-dimensional object W is built in a shape defined by the 3D model data MD in the three-dimensional data TDD, and the image defined by the image profile is formed on the surface.

The inkjet printer 1 and the three-dimensional object building method according to the embodiment described above are capable of suitably adjusting the color parameter depending on the angle of the surface of the color portion WC with which the color becomes lighter when the color portion WC is in a more horizontal state, the color becomes darker when the color portion WC is in a more vertical state, and the like. This is because the density of each color of the image profile is adjusted by the color adjustment parameter, according to the angle θ that is a value corresponding to the angle of the surface of the color portion WC relative to the reference plane BL. Consequently, it is possible to accurately reproduce the color of the three-dimensional object W on the three-dimensional data TDD.

Moreover, in the inkjet printer 1 and the three-dimensional object building method, the color adjustment parameter adjusts the density of each color of the image profile so as the color becomes lighter as the surface of the color portion WC approaches the horizontal state, and the color becomes darker as the surface of the color portion WC approaches the vertical state. Consequently, it is possible to accurately reproduce the color of the three-dimensional object W on the three-dimensional data TDD.

Furthermore, the inkjet printer 1 and the three-dimensional object building method are capable of accurately determining the value of the color adjustment parameter, when the angle of the color portion WC is calculated on the basis of the positional information on the vertex of each of the unit cells UC on the surface of the three-dimensional object W.

Still furthermore, the inkjet printer 1 and the three-dimensional object building method are capable of suitably adjusting the color parameter depending on the angle of the color portion WC, and adjusting the color parameter so as the color viewed at different viewing angles is uniform even if the thickness of the color portion WC is constant. This is because the color adjustment parameter is a value for adjusting the ejection amount of the ink that forms the color portion WC. Consequently, it is possible to lighten the color, particularly when the user wishes to lighten the color but the thickness of the color portion WC cannot be reduced, and to accurately reproduce the color of the three-dimensional object W on the three-dimensional data TDD.

Still furthermore, the inkjet printer 1 and the three-dimensional object building method are capable of calculating the angle of the surface of the color portion WC in a precise manner, forming a suitable color according to each position on the surface of the three-dimensional object W, and obtaining a high quality image, because the angle θ between the normal vector NV of the unit cell UC and the reference plane BL is a value corresponding to the angle of the surface of the color portion WC relative to the reference plane BL.

[First Modification]

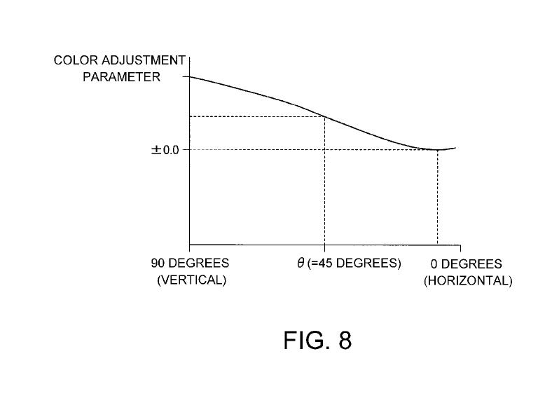

FIG. 8 is a diagram for explaining a color adjustment parameter of an image profile in a three-dimensional object building method according to a first modification of the embodiment. In FIG. 8, the same reference numerals denote the same portions as those in the embodiment described above, and the description thereof will be omitted.

The first modification of the embodiment is the same as the embodiment, except that the determination method of the color adjustment parameter of the image profile differs from that of the embodiment. In the first modification of the embodiment, as illustrated in FIG. 8, the output module 72 of the control device 7 determines the value of the color adjustment parameter of each of the unit cells UC, on the basis of a relation between the angle θ and the color adjustment parameter. The horizontal axis in FIG. 8 represents the angle θ, and the vertical axis represents the value of the color adjustment parameter to be added to the density of each color of yellow (Y), magenta (M), cyan (C), and black (K) of the image profile. In FIG. 8, when the angle θ is 0 degrees, the value of the color adjustment parameter is 0.0. When the angle θ exceeds 0 degrees, in other words, when the surface of the color portion WC is inclined from the horizontal state, the value of the color adjustment parameter exceeds 0.0 and becomes a plus value. When the angle θ exceeds 45 degrees, in other words, when the surface of the color portion WC approaches the vertical state, the value of the color adjustment parameter will be further increased.

Similar to the embodiment, the inkjet printer 1 and the three-dimensional object building method of the first modification are capable of accurately reproducing the color of the three-dimensional object W on the three-dimensional data TDD.

[Second Modification]

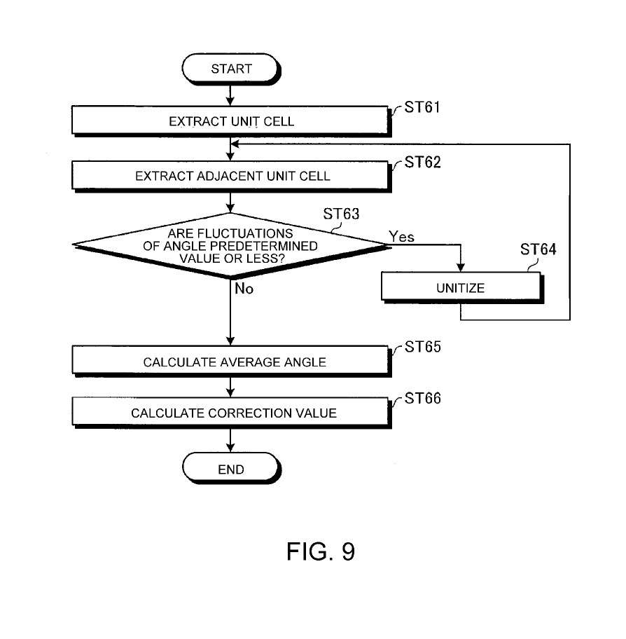

FIG. 9 is a flowchart illustrating a parameter value determining process in a three-dimensional object building method according to a second modification of the embodiment. In FIG. 9, the same reference numerals denote the same portions as those in the embodiment described above, and the description thereof will be omitted.

The second modification of the embodiment is the same as the embodiment, except that the parameter value determining process (step ST6) is different from that of the embodiment. In the parameter value determining process (step ST6) of the second modification of the embodiment, the output module 72 of the control device 7 obtains the color unit CU (illustrated in FIG. 6) that is formed of the unit cells UC in which the fluctuations of the angle θ of the normal vector NV are a predetermined value or less. In the parameter value determining process (step ST6) of the second modification of the embodiment, the output module 72 of the control device 7 calculates the average angle of the angles θ between each of the normal vectors NV of the unit cells UC that form the color unit CU and the reference plane BL, and determines the value of the color adjustment parameter and/or the value of the surface state adjustment parameter, on the basis of the average angle for each color unit CU in the cross-sectional slice information. In other words, in the cross-sectional slice information, the color unit CU is formed of the adjacent unit cells UC, and the fluctuations of the angle θ of the normal vector NV of the unit cells UC that form the color unit CU relative to the reference plane BL are a predetermined value or less.

Specifically, in the parameter value determining process (step ST6) of the second modification of the embodiment, the output module 72 of the control device 7 extracts any one of the unit cells UC in the cross-sectional slice information of each layer L (step ST61). The output module 72 of the control device 7 then extracts another unit cell UC that is adjacent to the extracted unit cell UC (step ST62). The output module 72 of the control device 7 calculates the fluctuations (standard deviation) of the angle θ of the normal vector NV of the extracted unit cell UC relative to the reference plane BL, and determines whether the calculated fluctuations are a predetermined value or less (step ST63).

When it is determined that the calculated fluctuations are a predetermined value or less (Yes at step ST63), the output module 72 of the control device 7 forms the color unit CU by the extracted unit cells UC (step ST64), and returns to step ST62. When it is determined that the calculated fluctuations are not a predetermined value or less (No at step ST63), the output module 72 of the control device 7 calculates the average angle of the angles θ of each of the normal vectors NV of the unit cells UC that form the color unit CU relative to the reference plane BL (step ST65), calculates the value of the color adjustment parameter and/or the value of the surface state adjustment parameter (step ST66) using the calculated average angle, and the process proceeds to the parameter reflecting process (step ST7). To calculate the value of the color adjustment parameter at step ST66, the value of the color adjustment parameter of the image profile may be calculated (step ST66) on the basis of a relation with the calculated average angle illustrated in FIG. 7 or FIG. 8, and the process may proceed to the parameter reflecting process (step ST7). In this manner, the output module 72 of the control device 7 calculates the color unit CU by repeating from step ST62 to step ST64, until it is determined that the calculated fluctuations are not a predetermined value or less.

Similar to the embodiment, the inkjet printer 1 and the three-dimensional object building method of the second modification are capable of accurately reproducing the color and/or the surface state of the three-dimensional object W on the three-dimensional data TDD. Moreover, the inkjet printer 1 and the three-dimensional object building method of the second modification calculates the value of the color adjustment parameter and/or the value of the surface state adjustment parameter, on the basis of the average angle of the angles θ between each of the normal vectors NV of the unit cells UC that form the color unit CU and the reference plane BL. Consequently, the inkjet printer 1 and the three-dimensional object building method of the second modification are capable of reducing the time required for calculating the value of the color adjustment parameter.

Furthermore, the inkjet printer 1 and the three-dimensional object building method of the second modification are capable of keeping the surface of the unit cells UC that form the color unit CU in substantially parallel, because the fluctuations of the angle θ of the normal vector NV of the unit cells UC that form the color unit CU are a predetermined value or less. Consequently, the inkjet printer 1 and the three-dimensional object building method of the second modification are capable of obtaining a high-quality image even if the time required for calculating the value of the color adjustment parameter and/or the value of the surface state adjustment parameter is reduced.

[Third Modification]

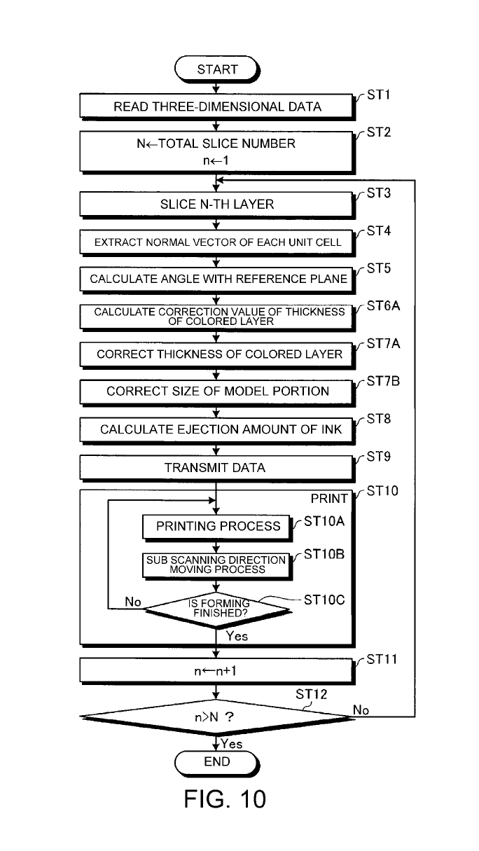

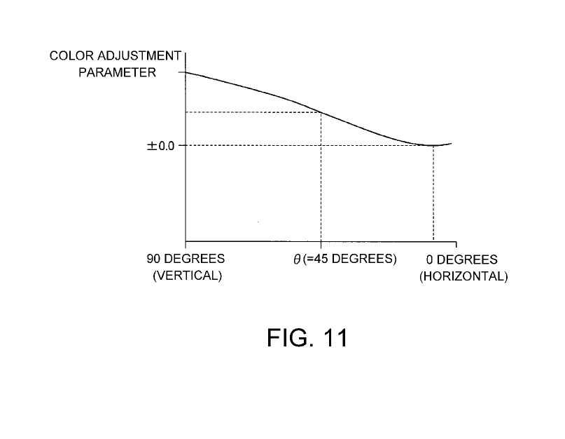

FIG. 10 is an example of a flowchart of a three-dimensional object building method according to a third modification of the embodiment. FIG. 11 is a diagram for explaining a color adjustment parameter of an image profile in the three-dimensional object building method according to the third modification of the embodiment. In FIG. 10 and FIG. 11, the same reference numerals denote the same portions as those in the embodiment described above, and the description thereof will be omitted.

In the third modification of the embodiment, the slice module 71 of the control device 7 divides the three-dimensional data TDD into the layers L to calculate the cross-sectional slice information in which the thickness of the color portion WC is a predetermined thickness in the slice information calculating process (step ST3). The slice module 71 of the control device 7 then calculates the normal vector NV of each of the unit cells UC in the cross-sectional slice information of each layer L (step ST4), and calculates the angle θ of the normal vector NV of each of the unit cells UC relative to the reference plane BL (step ST5).

Then, in a parameter value determining process (step ST6A), the output module 72 of the control device 7 calculates the value of the color parameter for adjusting the thickness of the color portion WC. Specifically, as illustrated in FIG. 11, the output module 72 of the control device 7 determines the value of the color adjustment parameter, on the basis of a relation between the angle θ of each of the unit cells UC or the average angle of the angles θ of the unit cells UC that form the color unit CU, and the color adjustment parameter. The horizontal axis in FIG. 11 represents the angle θ, and the vertical axis represents the value of the color adjustment parameter to be added to the thickness of the color portion. In FIG. 11, when the angle θ is 0 degrees, the value of the color adjustment parameter is 0.0. When the angle θ exceeds 0 degrees, in other words, when the surface of the color portion WC is inclined from the horizontal state, the value of the color adjustment parameter exceeds 0.0, and becomes a plus value. When the angle θ exceeds 45 degrees, in other words, when the surface of the color portion WC approaches the vertical state, the value of the color adjustment parameter is further increased.

The output module 72 of the control device 7 then performs a parameter reflecting process (step ST7A) that reflects, on the cross-sectional slice information, the value of the color adjustment parameter determined in the parameter value determining process (step ST6A). Specifically, in the parameter value determining process (step ST6A), the output module 72 of the control device 7 adds the value of the color adjustment parameter calculated for each of the unit cells UC and the like, to the thickness of the color portion WC in the cross-sectional slice information. In this example, when the thickness of the color portion WC is changed, the size of the model portion WM needs to be changed, because the size of the finished three-dimensional object W will be changed. In other words, when the color portion WC is increased, the model portion WM needs to be reduced as much as the increase. Thus, the size (thickness) of the model portion WM is corrected (step ST7B), after the parameter reflecting process is performed at step ST7A. Similar to the embodiment, the control device 7 then builds the three-dimensional object W by forming the three-dimensional object W for each layer L.

Similar to the embodiment, the inkjet printer 1 and the three-dimensional object building method of the third modification are capable of accurately reproducing the color of the three-dimensional object W on the three-dimensional data TDD. Moreover, the inkjet printer 1 and the three-dimensional object building method of the third modification are capable of making the color viewed at different viewing angles to be uniform, and accurately reproducing the color of the three-dimensional object W on the three-dimensional data TDD, because the color adjustment parameter is a value for adjusting the thickness of the color portion WC.

[Fourth Modification]

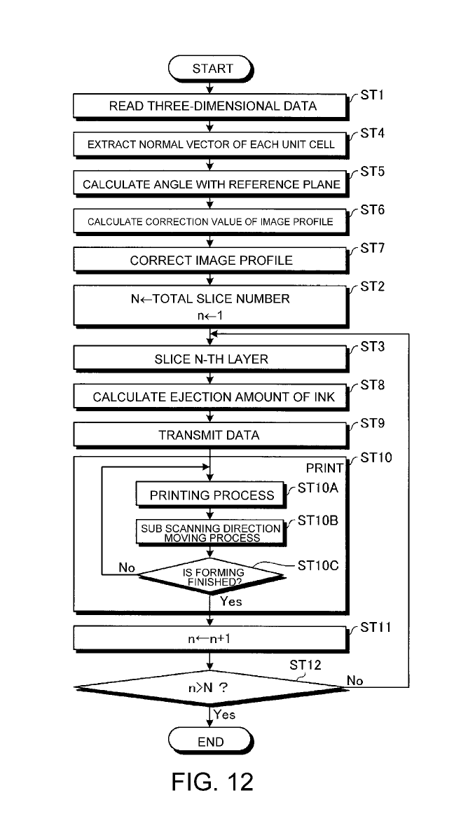

FIG. 12 is an example of a flowchart of a three-dimensional object building method according to a fourth modification of the embodiment. In FIG. 12, the same reference numerals denote the same portions as those in the embodiment described above, and the description thereof will be omitted.

In the three-dimensional object building method according to the fourth modification of the embodiment, the value of the color adjustment parameter and/or the value of the surface state adjustment parameter determined in the parameter value determining process (step ST6) are reflected to the density and/or the surface roughness of each color that is the color parameter of the image profile of the entire three-dimensional data TDD in the parameter reflecting process (step ST7). In the three-dimensional object building method according to the fourth modification of the embodiment, the three-dimensional data TDD reflected with the value of the color adjustment parameter is divided into the layers L to calculate the cross-sectional slice information of each of the layers L in the slice information calculating process (step ST3).

Specifically, after the three-dimensional data TDD of the three-dimensional object W is read from the input device 8 to the control device 7 (step ST1), the slice module 71 of the control device 7 extracts the normal vector NV of each of the unit cells UC in the three-dimensional data TDD (step ST4), and performs the angle calculating process (step ST5) that calculates the angle θ between each normal vector NV and the reference plane BL.

Next, the control device 7 performs the parameter value determining process (step ST6), and performs the parameter reflecting process (step ST7) that reflects, on the three-dimensional data TDD, the value of the color adjustment parameter and/or the value of the surface state adjustment parameter determined in the parameter value determining process (step ST6). The slice module 71 of the control device 7 then calculates the number N of the layer L that divides the three-dimensional data TDD of the three-dimensional object W in the Z-axis direction (step ST2), and performs the slice information calculating process (step ST3). The output module 72 of the control device 7 then generates the ejection amount and the ejection pattern of each of the ejection units 41Y, 41M, 41C, 41K, 41W, and 41CL for each layer L of the three-dimensional object W, and generates the ejection control amount capable of implementing the generated ejection pattern, the curing control amount, the control amount of the carriage driving unit 5 and the placing table driving unit 6, and the like (step ST8).

Next, the output module 72 of the control device 7 transmits the ejection amount and the like of each of the ejection units 41Y, 41M, 41C, 41K, 41W, and 41CL to each of the ejection units 41Y, 41M, 41C, 41K, 41W, and 41CL, and the ultraviolet ray irradiator 42 (step ST9), and performs the unit layer forming process (step ST10). Next, the control device 7 acquires n=n+1 (step ST11), determines whether n has exceeded N (step ST12), and sequentially builds the three-dimensional object W from the lower layer L.

Similar to the embodiment, the inkjet printer 1 and the three-dimensional object building method of the fourth modification is capable of accurately reproducing the color of the three-dimensional object W on the three-dimensional data TDD. The inkjet printer 1 and the three-dimensional object building method of the fourth modification are also capable of accurately reproducing the color of the three-dimensional object W on the three-dimensional data TDD such as when the thickness of the color portion WC is to be adjusted, because the cross-sectional slice information is calculated after the value of the color adjustment parameter is reflected on the three-dimensional data TDD.

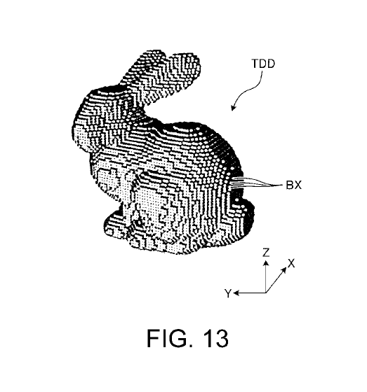

In the embodiment described above, the three-dimensional data TDD includes the 3D model data MD and the image profile. However, in the present disclosure, as illustrated in FIG. 13, the three-dimensional data TDD may also be formed of a plurality of voxels BX serving as unit cells arranged on the three-dimensional coordinates of the X-axis, the Y-axis, and the Z-axis. In this case, each of the voxels BX is formed in a cube, and includes coordinate data representing coordinates on the X-axis, the Y-axis, and the Z-axis, the normal vector NV, and the image profile.

In the present disclosure, the inkjet printer 1 may also include a support ink ejection unit for ejecting support ink that changes the degree of cure upon exposure on the working surface 2a. The support ink forms a support body (not illustrated) along the contour of the three-dimensional object W. In this example, the support ink that changes the degree of cure upon exposure may be ultraviolet (UV) curing ink that is cured by being irradiated with ultraviolet rays, for example. For example, it is preferable that the support ink is highly water soluble, highly alcohol soluble, or heat-soluble after curing. The support ink ejection unit is electrically connected to the control device 7, and the control device 7 controls the drive of the support ink ejection unit.

In the present disclosure, the color adjustment parameter may also be reflected on the three-dimensional data TDD and the cross-sectional slice information.

While the embodiment of the present disclosure has been described as above, the present disclosure is not limited thereto. In the present disclosure, the embodiment may be performed by various other forms, and various omissions, replacements, and changes in combinations may be made without departing from the scope and spirit of the disclosure.

What is claimed is:

1. A three-dimensional object building method, comprising:
a slice information calculating process that divides a three-dimensional data of a three-dimensional object at least a part of which includes a colored layer into a plurality of layers to calculate a cross-sectional slice information of each of the layers;
a unit layer forming process that forms each of the layers based on the cross-sectional slice information, wherein the three-dimensional object building method builds the three-dimensional object by using a three-dimensional printer, and by repeating the unit layer forming process a plurality of times to deposit the layers;
a parameter value determining process that determines a value of a color adjustment parameter used for adjusting a color parameter for forming the colored layer and/or a value of a surface state adjustment parameter used for adjusting a surface state of the colored layer, according to a value of an angle of a surface of the colored layer of the three-dimensional object relative to a horizontal reference plane; and
a parameter reflecting process that reflects the value of the color adjustment parameter and/or the value of the surface state adjustment parameter determined in the parameter value determining process on at least one of the three-dimensional data and the cross-sectional slice information.

2. The three-dimensional object building method according to claim 1, wherein
the color adjustment parameter is a value used for adjusting at least one of an ejection amount of an ink for forming the colored layer, an ink density, a thickness of the colored layer, and a shade of the colored layer.

3. The three-dimensional object building method according to claim 1, wherein
the surface state adjustment parameter is a value used for adjusting thickness of each of the layers in the unit layer forming process.

4. The three-dimensional object building method according to claim 1, further comprising:
an angle calculating process that calculates a value corresponding to the angle by using a positional information on a surface of the three-dimensional object included in the three-dimensional data.

5. The three-dimensional object building method according to claim 4, wherein
the surface of the three-dimensional object is divided into a plurality of unit cells that are polygonal planes, in the three-dimensional data, and
an angle between a normal vector of each of the unit cells and the horizontal reference plane is calculated as a value of the angle in the angle calculating process.

6. The three-dimensional object building method according to claim 5, wherein
a color unit is formed by the unit cells that are adjacent to each other, in the three-dimensional data, and
an average angle of angles between each of the normal vectors of the unit cells that form the color unit and the horizontal reference plane is calculated, and a value of the color adjustment parameter is determined based on the average angle for each color unit in the parameter value determining process.

7. The three-dimensional object building method according to claim 6, wherein
fluctuations of an angle of each of the normal vectors of the unit cells that form the color unit are a predetermined value or less.

8. The three-dimensional object building method according to claim 2, further comprising:
an angle calculating process that calculates a value corresponding to the angle by using a positional information on a surface of the three-dimensional object included in the three-dimensional data.

9. The three-dimensional object building method according to claim 3, further comprising:
an angle calculating process that calculates a value corresponding to the angle by using a positional information on a surface of the three-dimensional object included in the three-dimensional data.

10. The three-dimensional object building method according to claim 2, wherein
the value of the color adjustment parameter determined in the parameter value determining process is reflected on the three-dimensional data in the parameter reflecting process, and
the three-dimensional data reflected with the color adjustment parameter is divided into a plurality of layers to calculate the cross-sectional slice information of each of the layers in the slice information calculating process.

11. The three-dimensional object building method according to claim 3, wherein
the value of the color adjustment parameter determined in the parameter value determining process is reflected on the three-dimensional data in the parameter reflecting process, and
the three-dimensional data reflected with the color adjustment parameter is divided into a plurality of layers to calculate the cross-sectional slice information of each of the layers in the slice information calculating process.

12. A three-dimensional printer that builds a three-dimensional object based on a three-dimensional data of the three-dimensional object at least a part of which includes a colored layer, the three-dimensional printer comprising:
an ejection unit that ejects an ink for building the three-dimensional object on a landing surface;
a relative moving unit that relatively moves the ejection unit and the landing surface; and
a control device that controls the ejection unit and the relative moving unit, wherein
the control device builds the three-dimensional object by performing a slice information calculating process that divides the three-dimensional data into a plurality of layers to calculate a cross-sectional slice information of each of the layers, and a unit layer forming process that forms each of the layers based on the cross-sectional slice information; and by repeating the unit layer forming process a plurality of times to deposit the layers, and
the control device performs:
a parameter value determining process that determines a value of a color adjustment parameter used for adjusting a color parameter for forming the colored layer, according to a value of an angle of a surface of the colored layer of the three-dimensional object relative to a horizontal reference plane, and
a parameter reflecting process that reflects the color adjustment parameter determined in the parameter value determining process on at least one of the three-dimensional data and the cross-sectional slice information.
